(19) United States
(12) Patent Application Publication
(10) Pub. No.: US 2014/0102362 A1
(43) Pub. Date: Apr. 17, 2014

(54) Apparatus for Applying Liquid

(71) Applicant: düspohl Maschinenbau GmbH, Schloss Holte-Stukenbrock (DE)

(72) Inventor: Uwe Wagner, Gutersloh (DE)

(73) Assignee: düspohl Maschinenbau GmbH, Schloss Holte-Stukenbrock (DE)

(21) Appl. No.: 14/044,241

(22) Filed: Oct. 2, 2013

(30) Foreign Application Priority Data
Oct. 15, 2012 (DE) 20 2012 009 804.7

(51) Int. Cl. B05C 5/02

(52) U.S. Cl. CPC B05C 5/0245
USPC 118/302; 118/300

(57) ABSTRACT

An apparatus for applying liquid onto web material (12), the apparatus including a transport system (10) for the web material, a slot nozzle (20) extending across the web material (12) and arranged for applying the liquid onto the web material, and at least one guide shaft (26) that extends in parallel with the slot nozzle and is arranged such that it guides the web material (12) closely past the slot nozzle (20), wherein the guide shaft (26) is configured as a tube and connected to a fluid source (30).

The invention relates to an apparatus for applying liquid onto web material, the apparatus comprising a transport system for the web material, a slot nozzle extending across the web material and arranged for applying the liquid onto the web material, and at least one guide shaft that extends in parallel with the slot nozzle an is arranged such that it guides the wed material closely past the slot nozzle.

This type of apparatus is used for example for applying hot-melt adhesive to webs of a decor material with which profiles for furniture, door frames, door blades and the like are to be coated. The web material passes over the guide shafts and is thereby guided such that it engages the mouth of the slot nozzle and preferably entwines a part of the surface of the slot nozzle. In case of delicate materials, e.g. polypropylene film, the friction between the web material and the guide shafts may cause damage to the film. e.g. by causing the film to be stretched or torn.

It is therefore an object of the invention to provide an apparatus of the type indicated above which permits a more gentle treatment of the web material.

According to the invention, in order to solve this problem, the guide shaft is configured as a tube and connected to a fluid source.

The invention offers the possibility to pass a fluid, e.g. air, through the guide shafts and thereby to cool the same while the apparatus is operating. Since the guide shafts are disposed in immediate vicinity of the slot nozzle that is heated at least to the melting temperature of the adhesive when the adhesive is being applied, the guide shafts get heated in the course of the operation. It has turned out that the friction coefficient for the friction between the guide shafts and the web material depends upon the temperature and increases with increasing temperature of the guide shafts. Thus, by cooling the guide shafts, the frictional resistance can be reduced and, consequently, the risk of a damage of the web material can be reduced.

Useful details and further developments of the invention are indicated in the dependent claims.

In a particularly preferred embodiment the tubular guide shaft has a series of radial bores that are directed towards the web material so that at least a part of the fluid exits from the guide shaft at a position where the web material engages the peripheral surface of the guide shaft. Then, the web material will hover on a fluid cushion, via by the friction is reduced significantly.

The apparatus is preferably configured such that the guide shafts engage or act upon a non-coated surface of the web material and are arranged to guide the web such that it is deflected at the slot nozzle.

An embodiment example will now be described in conjunction with the drawings, wherein:

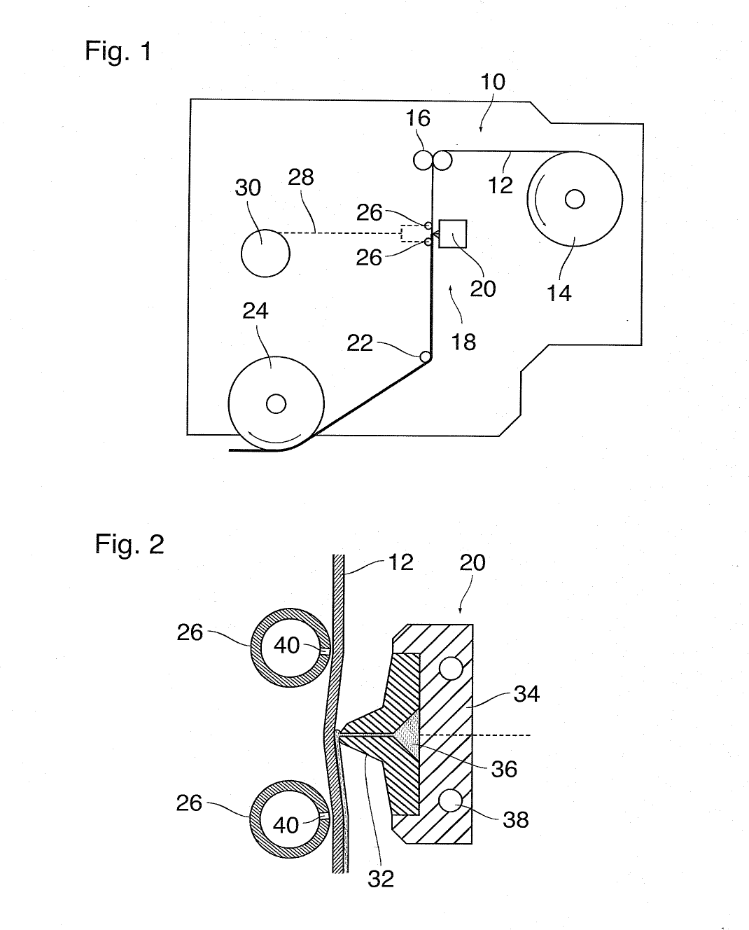

FIG. 1 is a sketch of an apparatus according to the invention; and

FIG. 2 is an enlarged cross-sectional view of a slot nozzle and two guide shafts of the apparatus shown in FIG. 1.

The apparatus shown in FIG. 1, comprises a transport system 10 for an endless web material 12 that is withdrawn from a coil 14. By means of a driven pair of tension rollers 16 the web material 12 is supplied to an adhesive station 18. There, a hot-melt adhesive is applied to the web material 12 by means of a heated slot nozzle 20. Then, via a deflection roller 22, the web material coated with the adhesive passes on to a pressure roller 24 with which the web material is applied to a profile member that has not been shown.

The web material 12 may for example be a plastic film, e.g. a polypropylene film having a width of 1400 mm or more, for example.

In the adhesive station 18 two stationary guide shafts 26 are arranged opposite to the slot nozzle 20 for holding the web material 12 in engagement with the mouth of the slot nozzle 20.

According to the invention, the guide shafts 26 are configured as tubes that are connected to a blower 30 via a branched line 28, so that air may be passed through the guide shafts 26. In this way, the guide shafts are cooled, and their temperature is kept on a value that is lower than the temperature of the hot-melt adhesive and the slot nozzle 20. As a result of the lower temperature of the guide shafts 26 the friction coefficient of the peripheral surface of the guide shafts in relation to the web material is reduced, so that the web material is subject to a smaller mechanical strain when it slides over the guide shafts 26.

FIG. 2 shows the slot nozzle and the guide shafts 26 on an enlarged scale. The slot nozzle 20 has a mouth piece 32 that is held in a holder 34 and has two projecting lips that are rounded-off at their free ends and delimit an exit slot for hot-melt adhesive 36. The holder 32 has heating passages 38 which serve for keeping the mouth piece 32 on a temperature that is at least equal to the melting temperature of the adhesive 36.

The guide shafts 26 are disposed such that they gently press the web material 12 against the lips of the mouth piece 32 so that the web material is slightly deflected and entwines around the rounded lips of the mouth piece. This helps to assure that a layer of adhesive 36 with uniform thickness is applied to the web material.

Since the guide shafts 26 are disposed in immediate vicinity of the heated slot nozzle 20, they are heated themselves through heat radiation and partly through heat conduction, so that their temperature will increase in the course of operation of the apparatus. However, this rise in temperature is limited by the fact that air supplied from the blower 30 is passed through the tubular guide shafts.

Moreover, in the example shown here, the guide shafts 26 have radial bores 40 that are directed towards the web material 12 or, more exactly, towards those positions where the non-coated side of the web material 12 would engage the peripheral surface of the guide shaft.

Moreover, the guide shafts are closed or at least obstructed at their downstream end, so that the air supplied from the blower 30 via the line 28 is forced to exit through the radial bores 40. In this way, the web material 12 is generally caused to hover on an air cushion and may therefore pass over the guide shafts practically without friction. If, nevertheless, the web material should occasionally come into contact with the periphery of one of the guide shafts, the low temperature of the latter will assure that the frictional resistance is still within tolerable limits, so that an undesired stretching or tearing of the web material 12 can be avoided reliably.

In place of individual bores 14, the guide shafts could optionally have a continuous slot.

As fluid source, a compressed air source may be provided in place of the blower 30.

1. An apparatus for applying liquid onto a web material, the apparatus comprising:
a transport system for the web material,
a slot nozzle extending across the web material and arranged for applying the liquid onto the web material, and
at least one guide shaft that extends in parallel with the slot nozzle and is arranged such that it guides the web material closely past the slot nozzle, the guide shaft being configured as a tube and connected to a fluid source.

2. The apparatus according to claim 1, where at least one said guide shaft has at least one radial opening directed towards the web material for creating a fluid cushion between a peripheral surface of the guide shaft and the web material.

3. The apparatus according to claim 2, wherein said at least one radial opening is formed by a series of bores distributed evenly in regard to a width of the web material

4. The apparatus according to claim 2, wherein the fluid source is a blower.

5. The apparatus according to claim 2, wherein the fluid source is a compressed air source.

6. The apparatus according to claim 1, wherein the slot nozzle is heated.
